(19) United States
(12) Patent Application Publication
(10) Pub. No.: US 2014/0354606 A1
(43) Pub. Date: Dec. 4, 2014

(54) Display Device for Displaying Images

(71) Applicant: Himax Technologies Limited, Tainan City (TW)

(72) Inventors: Peng-Chi Chen, Tainan City (TW); Chan-Fei Lin, Tainan City (TW); Yu-Shan Chu, Tainan City (TW); Guo-Ming Lee, Tainan City (TW)

(73) Assignee: Himax Technologies Limited, Tainan City (TW)

(21) Appl. No.: 13/903,031

(22) Filed: May 28, 2013

(51) Int. Cl. G09G 5/18

(52) U.S. Cl. CPC G09G 5/18
USPC 345/204

(57) ABSTRACT

A display device includes a printed circuit board, a timing controller, a display panel, a plurality of source drivers, and a plurality of traces. The timing controller is disposed on the printed circuit board for generating a plenty of differential pairs. The source drivers which are disposed on the display panel for receiving the differential pairs are respectively assigned with an identification number, in which each of the source drivers determines a polarity of the differential pair received according to a corresponding identification number assigned to the source driver. Flexible printed circuit boards are connected to the printed circuit board and the display panel, and each of the flexible printed circuit boards is corresponding to some of the source drivers. The traces carrying the differential pairs are connected to the timing controller and to the source drivers through the flexible printed circuit boards.

### BACKGROUND

1. Field of Invention The present invention relates to a display panel. More particularly, the present invention relates to a chip on glass display panel.

2. Description of Related Art

With the progress of an information-dependent society, the demand for various display devices has increased. To meet such a demand, efforts have been made to research flat panel display devices such as liquid crystal display (LCD) devices, plasma display panels (PDPs), electro-luminescent display (ELD) devices, vacuum fluorescent display (VFD) devices, and the like. Some types of such flat panel display devices are being practically applied to various appliances for display purposes. These displays usually employ printed circuit boards (PCBs) to accommodate a plenty of elements.

The PCB functions to mechanically fix a timing controller and other components. The LCDs are provided with a timing controller (hereinafter referred to as “T-CON”) for supplying a clock signal and image data signals synchronized with the clock signal to source drivers for driving a display panel.

For signal transmitted from the T-CON to the source drivers, a transmission method using differential pairs such as a mini-LVDS (Low Voltage Differential Signaling) or RSDS™ (Reduced Swing Differential Signaling) interface technology has been widely used for fewer traces and minimizing Electro-magnetic Interference (hereinafter referred to as “EMI”).

Various techniques for enabling access to a wireless communication network, in particular, a wireless wide area network (WWAN), using a computer are being developed. However, due to various signals (especially the differential signals) transmitted to various components mounted on the PCB, the display device of the computer causes signal interferences when the computer accesses and communicates with a WWAN, thus generating WWAN noises which degrade the quality of communication and the reliability of the associated equipment.

### SUMMARY

According to one embodiment of the present invention, a display device for displaying a plurality of images is disclosed. The display device includes a printed circuit board, a timing controller, a display panel, a plurality of source drivers, a plurality of flexible printed circuit boards, and a plurality of traces. The timing controller is disposed on the printed circuit board for generating a plenty of differential pairs. The source drivers which are disposed on the display panel and receiving the differential pairs are respectively assigned with an identification number, in which each of the source drivers determines a polarity of the differential pair received according to a corresponding identification number assigned to the source driver.

The flexible printed circuit boards are connected to the printed circuit board and the display panel, in which each of the flexible printed circuit boards is corresponding to some of the source drivers. The traces carry the differential pairs, in which the traces are connected to the timing controller and to the source drivers through the flexible printed circuit boards.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a display device for displaying a plenty of images according to one embodiment of the present invention;

FIG. 2A and FIG. 2B are an illustrative diagrams of a display device for displaying a plenty of images according to one embodiment of the present invention;

FIG. 3 is a block diagram of a display device for displaying the images according to another embodiment of the present invention;

FIG. 4 is a block diagram of a display device for displaying the images according to still another embodiment of the present invention;

FIG. 5 is a block diagram of a display device for displaying the images according to another embodiment of the present invention; and

FIG. 6 is a frequency response diagram of measured noises of a display device for displaying the images.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

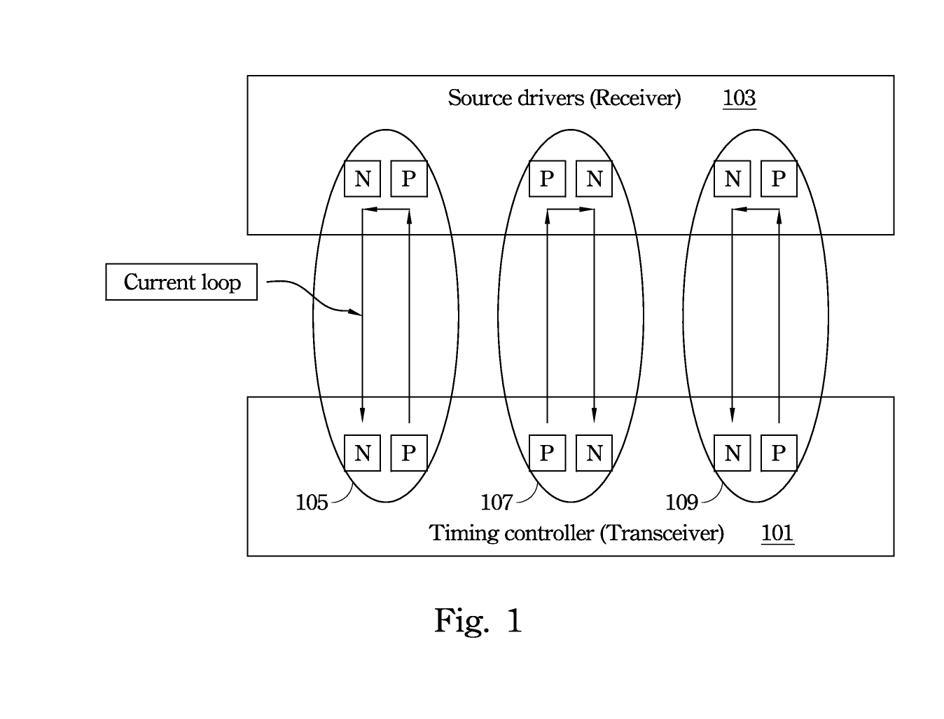

FIG. 1 is a schematic diagram of a display device for displaying a plenty of images according to one embodiment of the present invention. As shown in FIG. 1, a timing controller 101 sends differential signals to source drivers 103 through a differential pair 105, a differential pair 107, and a differential pair 109. Each of the differential pairs 105/107/109 is composed of a positive phase signal P and a negative phase signal N. If all of the differential pairs 105/107/109 had the same polarity, the induced current induced by those differential pairs due to the electromagnetic induction would flow in the same direction, which makes the noise problem even worse.

To reduce the noise problem, one embodiment of the present invention swaps (reverses) the polarity of the differential pairs 105/109 from the original PN to the new NP, and the direction of the induced current induced by the differential pair 107 is different from the direction of the induced current generated by the other two differential pairs 105/109. With such a swapping arrangement, the electro-magnetic Interference and the WWAN noises are reduced.

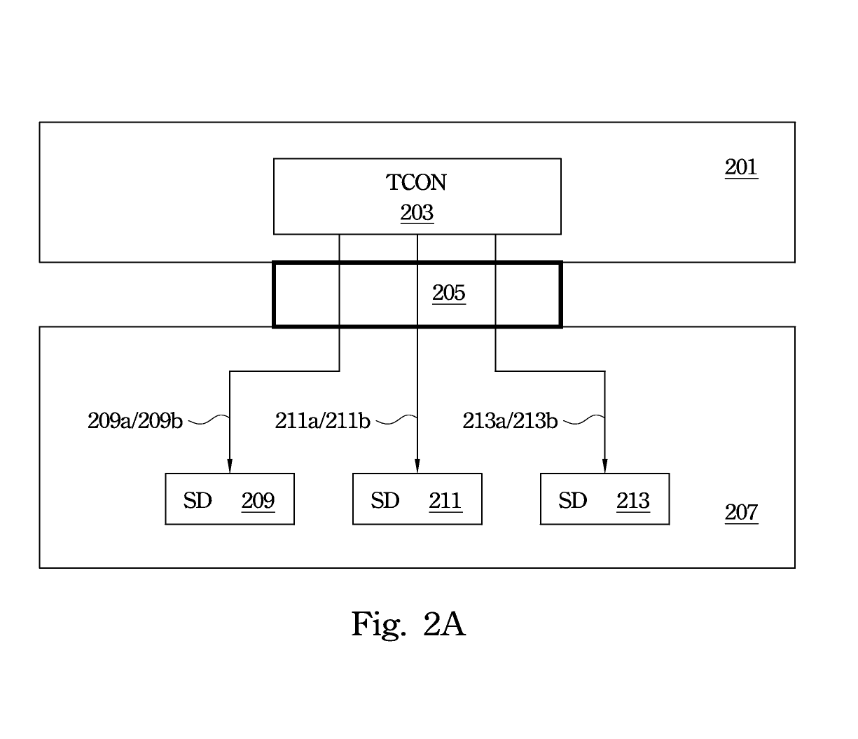

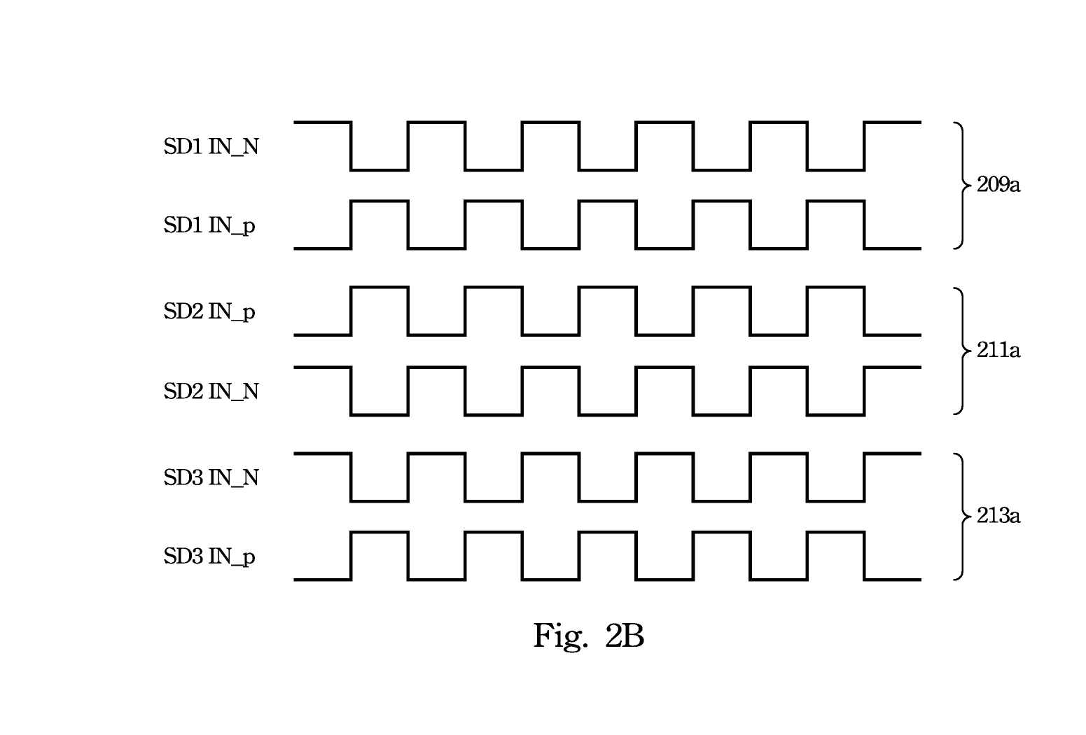

FIG. 2A and FIG. 2B are illustrative diagrams of a display device for displaying a plenty of images according to one embodiment of the present invention. The display device includes a printed circuit board 201, a timing controller (TCON) 203, a display panel 207, three source drivers 209/211/213, a flexible printed circuit board 205, and three traces 209b/211b/213b. The source drivers (SD) 209/211/213 are disposed on the display panel 207 which can be made of glass and receive the differential pairs 209a/211a/213a. The flexible printed circuit board 205 is connected to the printed circuit board 201 and the display panel 207. The traces 209b/211b/213b carry the differential pairs 209a/211a/213a, in which the traces 209b/211b/213b are connected to the timing controller 203 and to the source drivers 209/211/213 through the flexible printed circuit board 205.

Generally, at least one of the source drivers 209/211/213 which are adjacent to each other has swapped polarity for the corresponding differential pair. Those source drivers 209/211/213 are respectively assigned with identification numbers, such as 00, 01, 10, and each of the source drivers 209/211/213 determines the polarity of the received differential pair according to a corresponding identification number assigned to the source driver. For example, the source driver whose identification number is equal to 01 is designated to swap the polarity of the differential pair. Further, the source driver which is connected to the longest trace for carrying the differential pair is usually the one assigned with the identification number to change the polarity.

In this embodiment, when the source driver 209 and the source driver 213 read their identification numbers and realize that they should reverse (swap) the polarity of their differential pair 209a/213a, the polarity of their differential pair 209a/213a is changed from the original P N (i.e. the low voltage level leads the high voltage) into the new N P (i.e. the high voltage level leads the low voltage). In addition, the polarity of the differential pairs 209a/213a at the ends of the timing controller 203 should be changed to N P, accordingly.

With such an arrangement, induced currents induced by the differential pairs 209a/211a/213a have different directions, and the induced currents can be balanced. As a result, the electro-magnetic Interference and the WWAN noises are reduced.

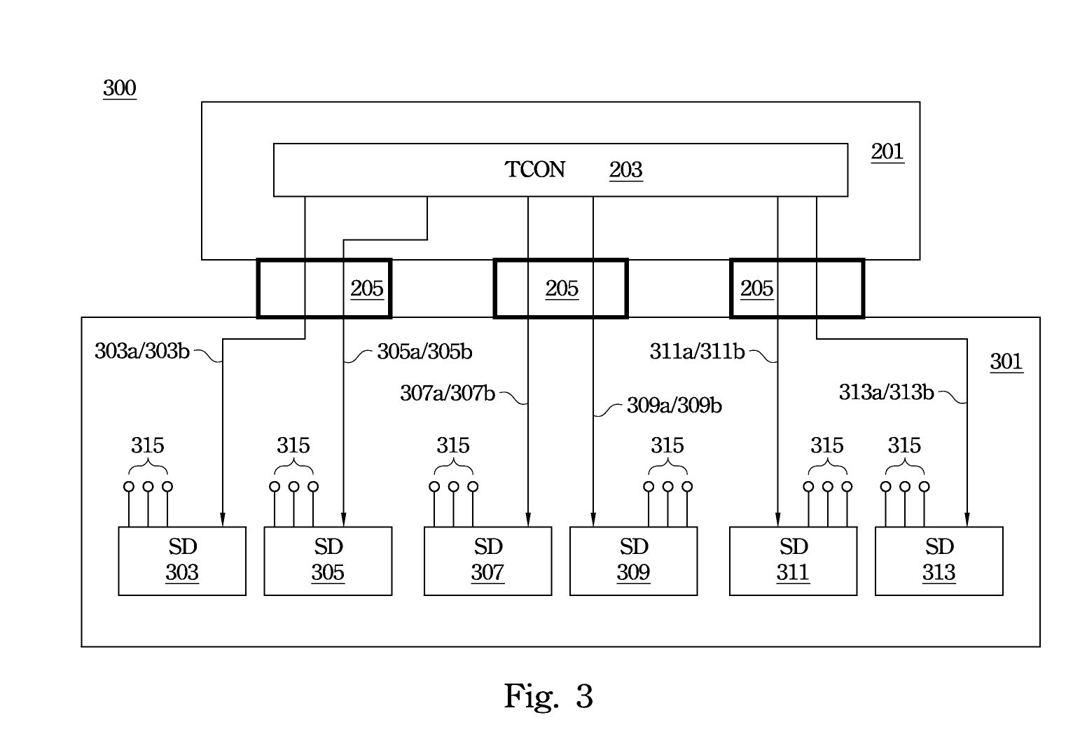

FIG. 3 is a block diagram of a display device for displaying the images according to another embodiment of the present invention. The display device 300 includes a printed circuit board 201, a timing controller (TCON) 203, a display panel 301, six source drivers 303/305/307/309/311/313, three flexible printed circuit boards 205, and several traces 303b/305b/307b/309b/311b/313b. The flexible printed circuit boards 205 are connected to the printed circuit board 201 and the display panel 301.

The source drivers (SD) 303/305/307 and the source drivers 309/311/313 are disposed on the display panel 301 and receive the differential pairs 303a/305a/307a/309a/311a/313a. The traces 303b/305b/307b/309b/311b/313b carry the differential pairs 303a/305a/307a/309a/311a/313a, in which the traces 303b/305b/307b/309b/311b/313b are connected to the timing controller 203 and connected to the source drivers 303/305/307/309/311/313 through the flexible printed circuit boards 205.

One of the source drivers which are connected to the same flexible printed circuit board has swapped polarity for the corresponding differential pair.

Specifically, one of the source drivers 303/305 connected to the same flexible printed circuit 205 needs to change to change its polarity for the differential pair 303a or the differential pair 305a. The rest of the source drivers (i.e. source drivers 307/309/311/313) change their polarities in the similar way.

Each of the source drivers 303/305/307/309/311/313 has a dc pin 315 disposed on the display panel 301, and the source drivers 303/305/307/309/311/313 read corresponding identification numbers from the dc pins 315 and determine the polarity for the differential pairs accordingly. The source drivers 303/305/307/309/311/313 are divided into an odd group and an even group according to their identification numbers, and the polarity for the differential pairs of the even group is swapped.

For example, the identification numbers assigned to the source drivers 303/305/307/309/311/313 are 000, 001, 010, 011, 100, 101, respectively, and the source drivers 303/307/311 having the identification numbers equal to 000, 010, 100 are defined as the even group which needs to change their polarity for the differential pairs. Alternatively, the source drivers 305/309/313 having the identification numbers equal to 001, 011, 101 defined as the odd group can replace the even group to change their polarities.

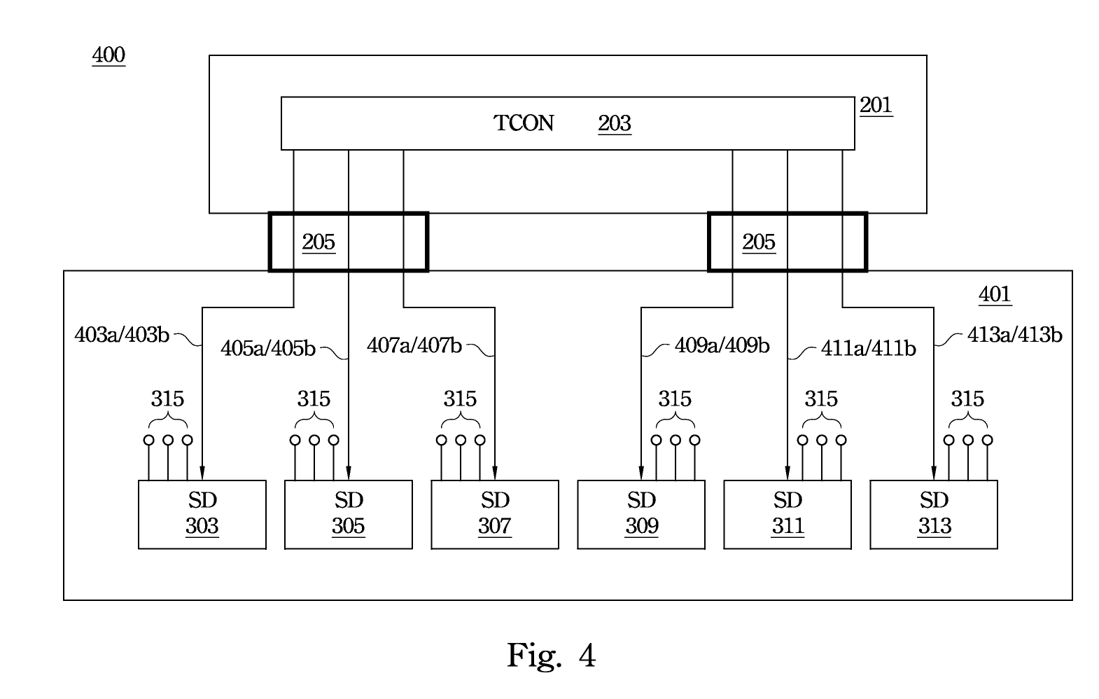

FIG. 4 is a block diagram of a display device for displaying the images according to still another embodiment of the present invention. The display device 400 includes a printed circuit board 201, a timing controller (TCON) 203, a display panel 401, six source drivers 303/305/307/309/311/313, two flexible printed circuit boards 205, and several traces 403b/405b/407b/409b/411b/413b. The flexible printed circuit boards 205 are connected to the printed circuit board 201 and the display panel 401.

The source drivers 303/305/307 and the source drivers 309/311/313 are arranged as shown in FIG. 3. The traces 403b/405b/407b/409b/411b/413b carry the differential pairs 403a/405a/407a/409a/411a/413a, in which the traces 403b/405b/407b/409b/411b/413b are connected to the timing controller 203 and connected to the source drivers 303/305/307/309/311/313 through the flexible printed circuit boards 205.

In this embodiment, the source drivers 303/307/309/313 which are connected to the traces 403b/407b/409b/413b having the length longer than other traces (i.e. traces 405b/411b) have swapped polarity for their differential pairs. When the source drivers 303/307/309/313 read their identification numbers which are respectively equal to 000, 010, 011, 101 from the dc pins 315, they realize that they should swap their polarity from PN to NP, and the polarity of corresponding differential pairs from the timing controller 203 is also swapped.

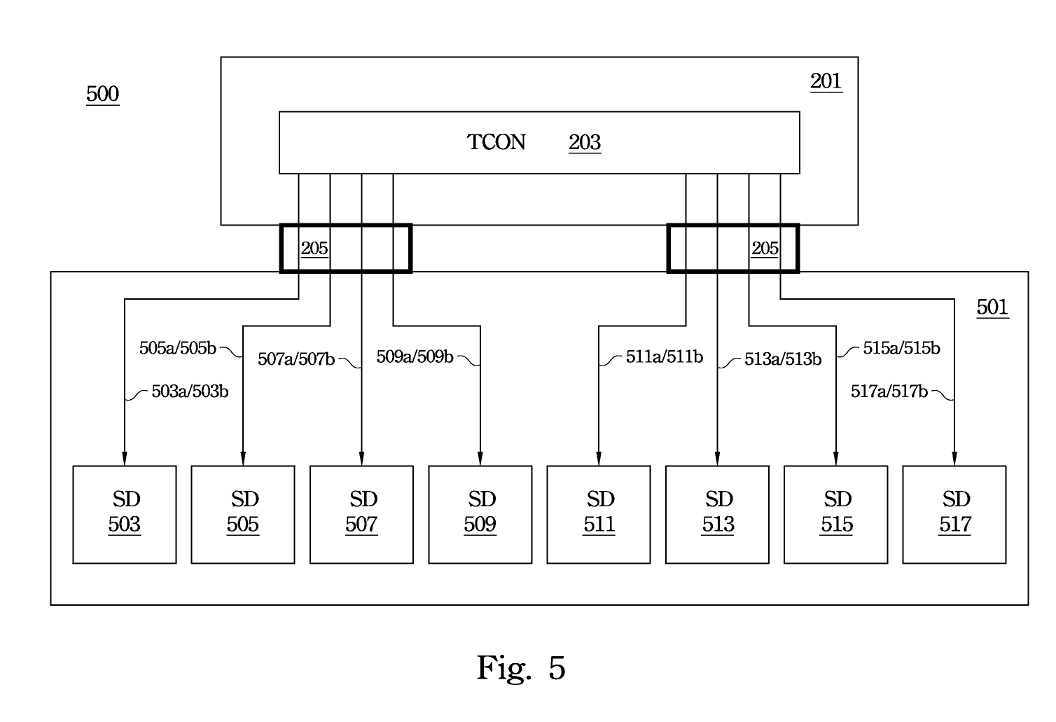

FIG. 5 is a block diagram of a display device for displaying the images according to the other embodiment of the present invention. The display device 500 includes a printed circuit board 201, a timing controller (TCON) 203, a display panel 501, eight source drivers 503/505/507/509/511/513/515/517, two flexible printed circuit boards 205, and several traces 503b/505b/507b/509b/511b/513b/515b/517b, in which the flexible printed circuit boards 205 are connected to the printed circuit board 201 and the display panel 501.

The source drivers 503/505/507/509 and the source drivers 511/513/515/517 are disposed on the display panel 501 and receive the differential pairs 503a/505a/507a/509a as well as the differential pairs 511a/513a/515a/517a. The traces 503b/505b/507b/509b and the traces 511b/513b/515b/517b carry the differential pairs 503a/505a/507a/509a and the differential pairs 511a/513a/515a/517a, in which those traces are connected to the timing controller 203 and connected to the source drivers 503/505/507/509/511/513/515/517 through the flexible printed circuit boards 205.

In this embodiment, there are eight source drivers and two flexible printed circuit, and the source drivers having the identification number equal to 000, 011, 100 and 111 have swapped polarity for the differential pairs.

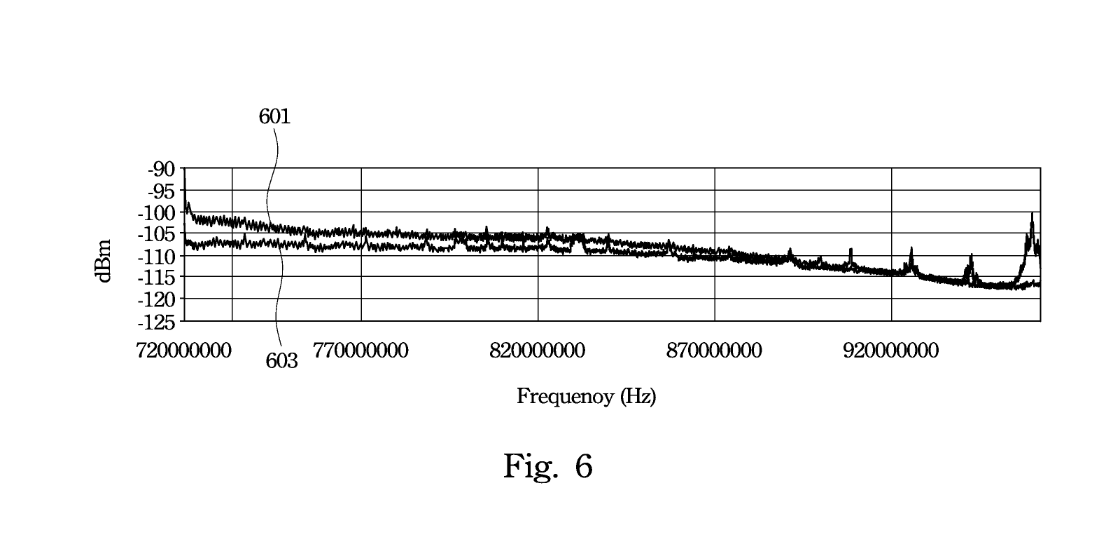

FIG. 6 is a frequency response diagram of the measured noise of a display device for displaying the images. The curve 601 presents the frequency response of the conventional display device, and the curve 603 present the frequency response of the display device according to one embodiment of the present invention which swaps the polarity for the differential pair of some source drivers. At a frequency of 720 Mhz, the noise occurring in the embodiment of the present invention is 5 dBm less than the noise in the conventional display device. Apparently, the polarity swapping method adapted by the embodiment of the present invention actually reduces the noises of the differential pairs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display device for displaying a plurality of images, the display device comprising:
a printed circuit board;
a timing controller disposed on the printed circuit board for generating a plurality of differential pairs;
a display panel;
a plurality of source drivers which are disposed on the display panel for receiving the differential pairs and respectively assigned with an identification number, wherein each of the source drivers determines a polarity of the differential pair received according to a corresponding identification number assigned to the source driver;
a plurality of flexible printed circuit boards connected to the printed circuit board and the display panel, wherein each of the flexible printed circuit boards is corresponding to some of the source drivers; and
a plurality of traces for carrying the differential pairs, wherein the traces are connected to the timing controller and to the source drivers through the flexible printed circuit boards.

2. The display device as claimed in claim 1, wherein each of the source drivers comprises a dc pin disposed on the display panel, and each of the source drivers reads the corresponding identification number from the dc pin and determines the polarity of the differential pair accordingly.

3. The display device as claimed in claim 1, wherein at least one of the source drivers which are adjacent to each other has swapped polarity for its corresponding differential pair.

4. The display device as claimed in claim 1, wherein there are three source drivers, and polarity for the differential pairs of a plurality of side sources drivers is swapped.

5. The display device as claimed in claim 1, wherein there are six source drivers and three flexible printed circuits, and one of the source drivers which are connected to the same flexible printed circuit board has swapped polarity for the corresponding differential pair.

6. The display device as claimed in claim 1, wherein the source drivers are divided into an odd group and an even group according to their identification number, and the polarity for the differential pairs of the even group is swapped.

7. The display device as claimed in claim 6, wherein the source drivers having the identification numbers equal to 000, 010, and 100 have the polarity swapped.

8. The display device as claimed in claim 1, wherein there are eight source drivers and two flexible printed circuit, and the source drivers having the identification numbers equal to 000, 011, 100 and 111 have swapped polarity for the differential pairs.

9. The display device as claimed in claim 1, wherein the source drivers which are connected to the traces having the length longer than others have swapped polarity for the differential pairs.
